(19) United States
(12) Patent Application Publication
(10) Pub. No.: US 2008/0294516 A1
(43) Pub. Date: Nov. 27, 2008

(54) ELECTRONIC ADVERTISING SYSTEM

(75) Inventors: Adam Leader, Scarsdale, NY (US); Spencer Spinnell, New York, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/753,537

(22) Filed: May 24, 2007

(51) Int. Cl. G06Q 30/00

(52) U.S. Cl. 705/14

(57) ABSTRACT

An electronic tearsheet is received at a receipt time from a publisher confirming placement at a placement time of a print ad in a publication according to specified terms between the publisher and an advertiser. The specified terms include a bid amount. The bid amount is collected from the advertiser. The publisher is provided a publisher's share of the bid amount. The publisher's share includes a base amount and a bonus. The bonus is based on a period of time between the receipt time and the placement time.

### TECHNICAL FIELD

This invention relates to advertising.

### BACKGROUND

An advertiser desiring to place an advertisement in a printed publication (a “print ad”) can enter into an agreement with a publisher of the publication. The agreement generally includes the terms associated with the placement of the print ad. For example, if a print ad is to be placed in a newspaper, the agreement can specify the dates the print ad is to run, the section in the newspaper to place the print ad, the print ad size, and possibly other parameters. Because printed publications include manual processes, human error can lead to a print ad not running according to the terms agreed to between the advertiser and the publisher. For example, the print ad simply may not run at all, the wrong print ad content may be published, the print ad may be inserted into the wrong section of the newspaper and/or may be sized incorrectly. Conventionally, a publisher provides a tearsheet (i.e., a page on which the print ad was placed in the publication) to the advertiser as proof the print ad ran in the publication. Human error can lead to an incorrect tearsheet being provided to the advertiser, even though the print ad was placed according to the terms of the agreement. These errors generally lead to lost opportunities for advertisers and lost revenue for publishers. An advertiser typically will not be charged (or will be given a discount), if the print ad is not placed according to the terms of an associated agreement.

### SUMMARY

This invention relates to an electronic advertising system and technique. In general, in one aspect, the invention features a computer-implemented method including receiving publisher information from multiple publishers and receiving an offer from an advertiser. The publisher information includes information about available print ad space. The offer specifies terms for placing a print ad in a publication of a publisher, the terms including a bid amount being an amount the advertiser is willing to pay for placing the print ad. An acceptance of the offer is received from the publisher. The print ad content is received from the advertiser and provided to the publisher. At a receipt time, an electronic tearsheet is received from the publisher confirming placement at a placement time of the print ad in the publication according to the terms. The bid amount is collected from the advertiser. A publisher's share of the bid amount is provided to the publisher, where the publisher's share comprises a base amount and a bonus, and the bonus is based on a period of time between the receipt time and the placement time.

In general, in another aspect, the invention features a computer-implemented method including receiving at a receipt time an electronic tearsheet from a publisher confirming placement at a placement time of a print ad in a publication according to specified terms between the publisher and an advertiser, the specified terms including a bid amount. The bid amount is collected from the advertiser. The publisher is provided a publisher's share of the bid amount. The publisher's share includes a base amount and a bonus, and the bonus is based on a period of time between the receipt time and the placement time.

In general, in another aspect, the invention features an electronic advertising system. The system includes a user interface configured to receive publisher information from multiple publishers, where publisher information includes information about a publication and available print ad space in the publication; and offers from multiple advertisers. An offer specifies terms for placing a print ad in a publication of a publisher, the terms including a bid amount being an amount the advertiser is willing to pay for placing the print ad. The system further includes means for electronically receiving print ad content from an advertiser and electronically providing the print ad content to a publisher, where the publisher has accepted an offer to place the print ad in a publication. The system further includes means for receiving at a receipt time an electronic tearsheet from a publisher confirming placement at a placement time of the print ad in the publication according to the terms. The system further includes means for calculating an amount payable to the publisher for placement of the print ad in the publication, the amount payable comprising a base amount and a bonus. The bonus is based on a period of time between the placement time and the receipt time and can be zero. The system further includes means for collecting the bid amount from the advertiser and providing to the publisher the calculated amount payable to the publisher.

Implementations of the inventions described above can include one or more of the following features. If the period of time between the receipt time and the placement time is 24 hours or less, then the bonus can be a first amount. If the period of time between the receipt time and the placement time is greater than 24 hours but less than 48 hours, then the bonus can be a second amount. In one example, the base amount can be 85% of the bid amount, the first amount can be 5% of the bid amount and the second amount can be 3% of the bid amount. If the period of time between the receipt time and the placement time is greater than 48 hours, then the bonus can be zero. In one example, the base amount depends on the period of time between the receipt time and the placement time and if the period of time exceeds a maximum allowable time then the base amount is zero. In another example, the bonus is a performance rating on a performance scale, where a value of the performance rating is based on the period of time between the placement time and the receipt time.

Implementations of the invention can realize one or more of the following advantages. Providing a performance-based bonus to a publisher encourages prompt uploading of electronic tearsheets. Prompt uploading of electronic tearsheets allows for prompt verification by an advertiser that a print ad actually ran as per the terms agree with the publisher (e.g., the correct print ad content in the correct section of the correct newspaper on the correct day at the correct size). Prompt knowledge of execution errors allows advertisers to implement contingency plan (e.g., other marketing efforts) as a supplement to an incorrectly placed ad. Additionally, prompt electronic tearsheet uploading allows for prompt billing and payment, permitting parties to be paid as soon as possible after a billable activity occurs.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an example electronic print ad management system.

FIG. 2 is a flowchart showing a example process for providing an electronic advertising system.

FIGS. 3A-D are example graphical user interfaces associated with one implementation of an electronic advertising system.

FIGS. 4A-B are example graphical user interfaces associated with one implementation of an electronic advertising system.

FIGS. 5A-C are example graphical user interfaces associated with one implementation of an electronic advertising system.

FIG. 6 is a flowchart showing an example process for calculating a publisher's share of a bid amount.

FIG. 7 is a schematic diagram of an example computer system.

Like reference symbols in the various drawings indicate like elements.

### DETAILED DESCRIPTION

Techniques, methods, apparatus and a system for advertising and advertising revenue management are described. The techniques, methods, apparatus and system can be used to facilitate print advertising, being advertising occurring in print for example, in newspapers, magazines, journals, periodicals, flyers, brochures, and other printed publications. An advertisement placed in a printed publication shall be referred to herein as a “print ad”.

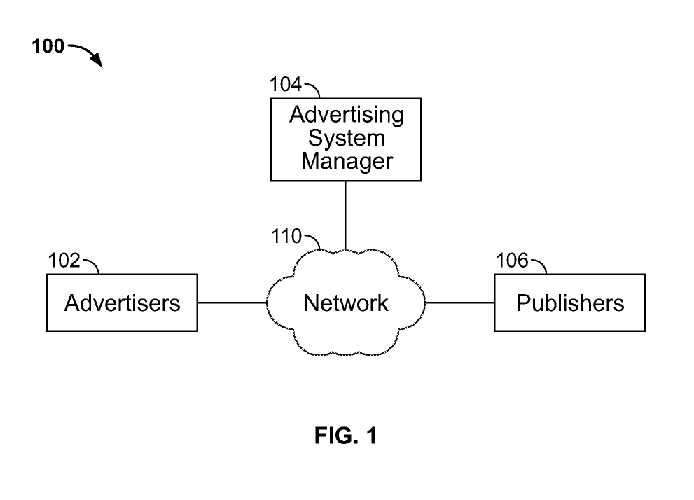

FIG. 1 is a block diagram of an example electronic print ad management system 100. The system 100 includes advertisers 102 and publishers 106. A publisher 106 is an entity that publishes content (e.g., print ads) or places content (e.g., print ads) for publication with another entity. By way of example, reference is made to placing print ads in a publication. Other forms of content can be delivered and published in accordance with the methods, apparatus and systems disclosed herein. An advertiser 104 is an entity that desires to place a print ad in a printed publication. The advertiser 104 can be a direct (e.g., an advertising entity) or indirect supplier (e.g., a middle man) of the print ad. The system further includes an advertising system manager 104. The advertising system manager 104 operates to bring the advertisers 102 and publishers 106 together by way, for example, of an online print ad marketplace, as is described further below. A computer network 110, such as a local area network (LAN), wide area network (WAN), the Internet, or a combination thereof, connects the advertisers 102, the advertising system manager 104 and the publishers 106.

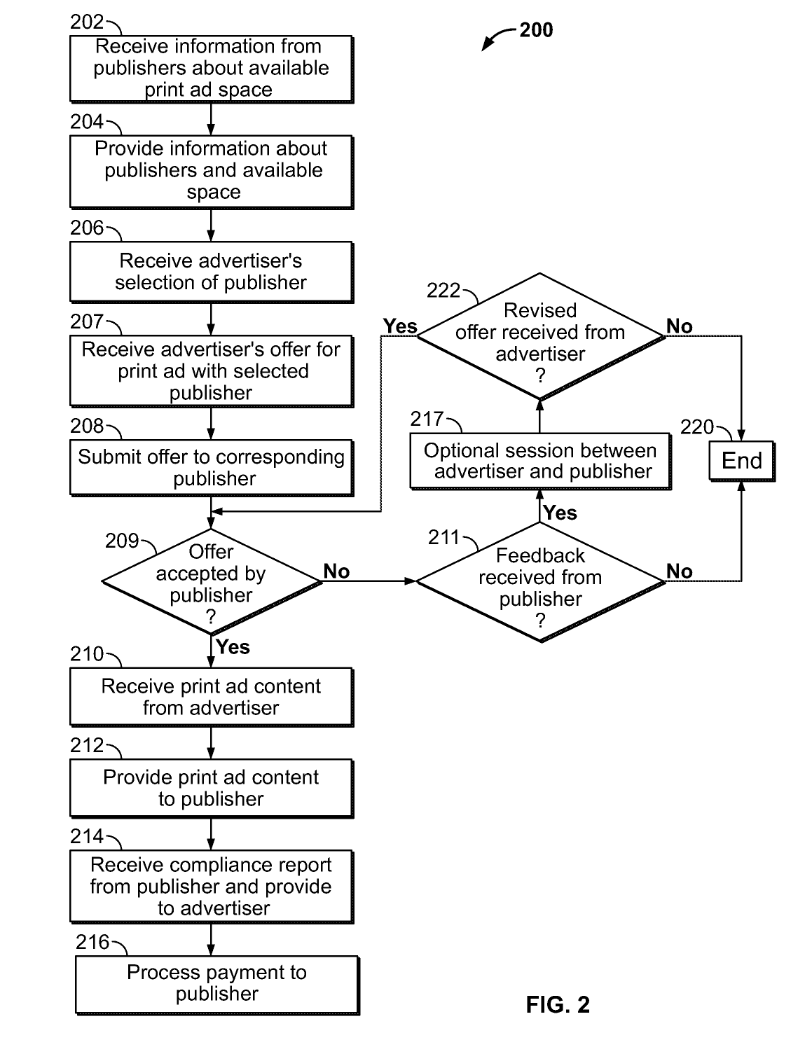

FIG. 2 is a flowchart showing an example process 200 for providing an electronic advertising system 100 (e.g., an online marketplace) for publishers 106 and advertisers 104, wherein one or more of the steps in the process can be carried out by, for example, the advertising system manager 104. Available print ad space is identified (step 202). For example, the publishers 106 can provide information to the advertising system manager 104 about available print ad space. The publisher information can include the name of the publication, the date or dates the publication is published, the location of the print ad space within the publication, the size and layout of the print ad space, whether the print ad will be run in black and white, color or either, and/or other information the publisher desires to provide to market their available print ad space.

Information associated with the publishers of the available print ad space is provided to advertisers (Step 204). For example, the advertising system manager 104 can provide an online marketplace in which publisher information provided by the publishers 106 is made available to the advertisers 102. In one implementation, the online marketplace is a web site. In this implementation, an advertiser 102 can be presented with a graphical user interface (GUI) through which the advertiser 102 can input certain choices about publishers with whom they would like to place ads. For example, the GUI can include checkboxes, drop-down menus, radio controls, data entry fields, and/or other user input controls or combinations thereof. In one implementation, the web site includes search capabilities. For example, if an advertiser 102 would like to search for a newspaper in a particular geographic location, the advertiser 102 can use the search capabilities to identify one or more newspapers meeting the advertiser's 102 geographic criteria, although a search query can be based on different and/or other search criteria as well.

An advertiser selects one or more publishers that the advertiser is interested in placing a print ad with (step 206). For example, using the web site provided by the advertising system manager 104, the advertiser 102 can provide input to the advertising system manager to choose one or more publishers 106 that the advertiser 102 is interested in placing ads with based on publisher information included on the web site. By way of illustrative example, consider an advertiser 102 that is interested in placing a print ad in a newspaper. In this example the publishers 106 are newspapers. The advertiser 102 can choose certain newspaper publishers 106, for example, based on factors such as geography, circulation size, ad size availability, section availability and other criteria. To the extent that a publisher 106 has provided publisher information relevant to these factors to the advertising system manager 104, the advertiser 102 has access to this information, through the advertising system manager 104, when choosing the newspaper publishers 106.

The advertiser creates an offer for one or more print ads with the selected publishers (step 207) and can submit the offer to the advertising system manager. The offer can include the specific terms associated with the advertisement including the price that the advertiser is willing to pay for placing the ad. For example, the advertiser 102 can select various parameters related to the desired advertising, such as the day(s)-of-week, desired newspaper section and ad size for each chosen newspaper publisher 106. The advertiser 102 can input a “bid amount” (e.g., a price the advertiser 102 is willing to pay to place an ad of the selected ad size in the chosen newspaper section on the selected day or days of the week). The advertiser's input, including the bid amount, constitutes the advertiser's “offer”.

In step 208, offers are submitted to corresponding publishers. For example, the advertising system manager 104 can submit the advertiser's offers to the corresponding publishers 106. In some implementations, submitting the offers can include sending an electronic message to the publishers that includes information about the offers. In some implementations, submitting the offers can include making the information about the offers available on a portion of a web site maintained by the advertising system manager 104, which may be accessible only to appropriate publishers. In some implementations, submitting the offers can include making the offers available on a particular portion of the web site and notifying the appropriate publishers of the availability of the offers by electronic message. Each publisher 106 can respond by either accepting or declining the offer. In one implementation, a publisher 106 can decline an offer but initiate an online (or offline) dialog with the advertiser 102 as to why the offer was not accepted and the two parties can attempt to reach an agreement satisfactory to both parties.

If an offer is accepted (“Yes” branch of decision step 209), the print ad content can be submitted (step 210). For example, the advertiser 102 can electronically submit corresponding print ad content to the publisher 106. Alternatively, the advertiser can supply print ad content with the offer. In one implementation, the advertiser 102 uploads an electronic file including the print ad content to the advertising system manager 104 and the advertising system manager 104 provides the electronic file to the publisher 106 (step 212).

If an offer is declined (“No” branch of decision step 209), a check can be made to determine if publisher feedback has been received (step 211). If so (“Yes” branch of decision step 211), an optional session between the advertiser and publisher can be initiated (step 216), during which, for example, the advertiser and publisher can continue negotiating terms associated with an ad placement. If no publisher feedback has been received (“No” branch of decision step 211), the process 200 can terminate (step 220). For example, if the publisher provides no comments or feedback to the advertiser 102 as to why the offer was declined, then the process terminates. However, if the publisher 106 does provide feedback to the advertiser 102, the advertiser 102 may be motivated to provide a revised offer (“Yes” branch of decision step 222), and the process returns to decision step 208. Otherwise, if the advertiser 102 does not provide a revised offer (“No” branch of decision step 222), the process terminates (Step 220).

Step 214 includes submission of a compliance report (e.g., an electronic tearsheet). For example, once the publisher 106 has run the ad (e.g., run the ad in the desired section in the newspaper on the selected date), the publisher 106 can provide proof that the ad ran to the advertising system manager 104. In one implementation, an electronic tearsheet can be uploaded to the electronic advertising system as proof that the ad ran according to agreed-upon terms. The electronic tearsheet can be an electronic file that includes an image of the ad as placed within the publication and can include enough information to show that the ad ran in the desired section of the newspaper on the selected date and according to any other specifications of the advertiser, e.g., ad size, ad color, font size, etc. In one implementation, the electronic tearsheet is a PDF file including a scanned representation of the page of the publication on which the ad ran.

Once an electronic tearsheet is uploaded by the publisher 106 to the advertising system manager 104, the advertising system manager 104 can provide the electronic tearsheet to the advertiser 102. For example, the advertising system manager 104 can forward the electronic tearsheet to the publisher by electronic message, by making the electronic tearsheet accessible in a portion of a web site to which the publisher has access, through a combination of providing access and sending an electronic messages, etc.

Once the advertising system manager 104 determines that the ad ran (e.g., by receiving an electronic tearsheet), the advertising system manager 104 can collect a bid amount from the advertiser 102 and transmit a publisher's share of the collected bid amount to the publisher 106 (Step 216).

In some implementations, an advertiser 102 can challenge the compliance report, i.e., the electronic tearsheet, within a specified period of time after the electronic tearsheet is uploaded. In particular, the advertiser 102 can, in some implementations, send a challenge message to the advertising system manager 104. The advertising system manager 104 may forward the message to the publisher 106, or the advertising system manager 104 may resolve any challenge raised by the advertiser directly (e.g., in an automated manner, or with human involvement, or with a combination of both). In some implementations, if it is determined that the ad was not run according to agreed-upon parameters, the bid amount may not be collected from the advertiser 102, and neither the advertising system manager 104 nor the publisher 106 may receive payment. A process for challenging a compliance report is described in further detail in U.S. patent application Ser. No. 11/753,407, entitled “Processing Electronic Tearsheets”, filed by Leader on May 24, 2007, the entire contents of which are hereby incorporated herein by reference.

In some implementations, the advertising system manager 104 automates many if not all steps in the process of either placing ads (e.g., steps taken by an advertiser 102) or selling ad space (e.g., steps taken by a publisher 106). For example, the advertising system manager 104 can automatically provide matches between advertisers 102 and publishers 106 based on their respective inputs (e.g., the advertisers' offers and the publishers' information). Further, the advertisers 102 can be provided with an electronic mechanism for uploading and transmitting the ad content to the publishers 106. The publishers 106 can be provided with an electronic mechanism for proving the ad was placed as agreed (e.g., in the form of an electronic tearsheet). Once both parties are satisfied their terms of the agreement (subject in some implementations to mediation by the advertising system manager 104), payment (e.g., the bid amount) can be automatically collected from the advertiser 102 and the publisher can be provided with the publisher's share of the bid amount.

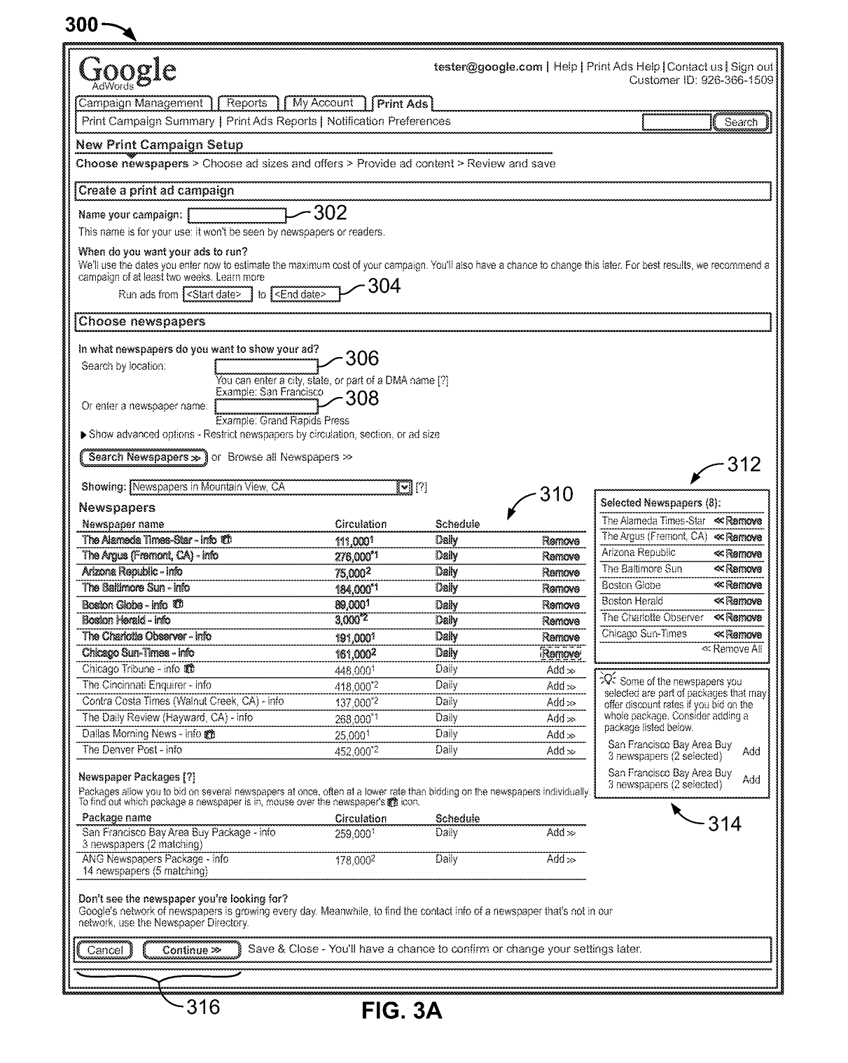

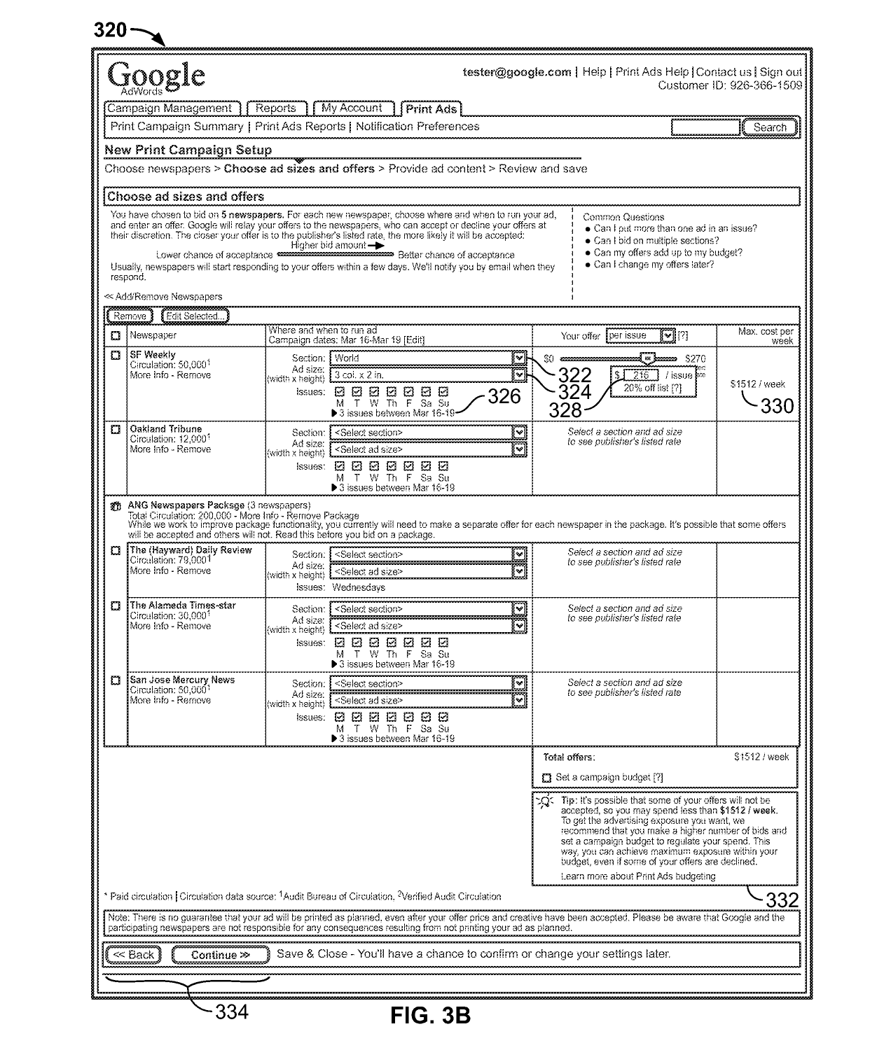

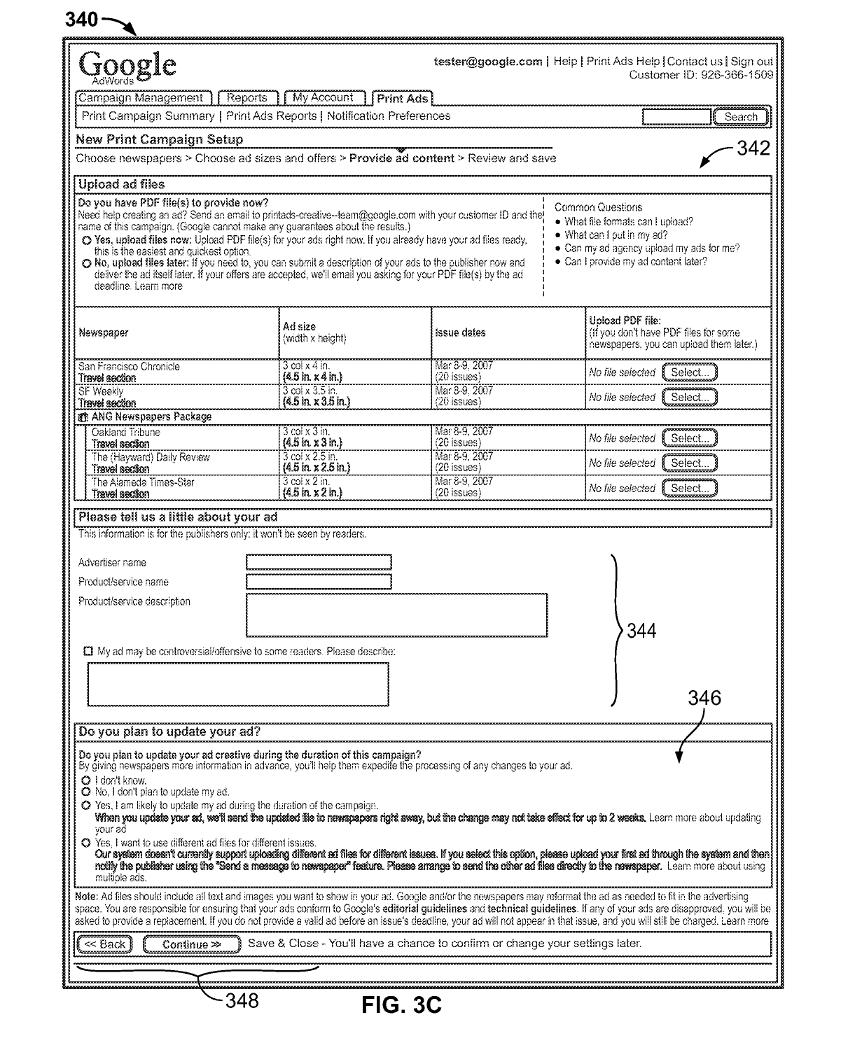

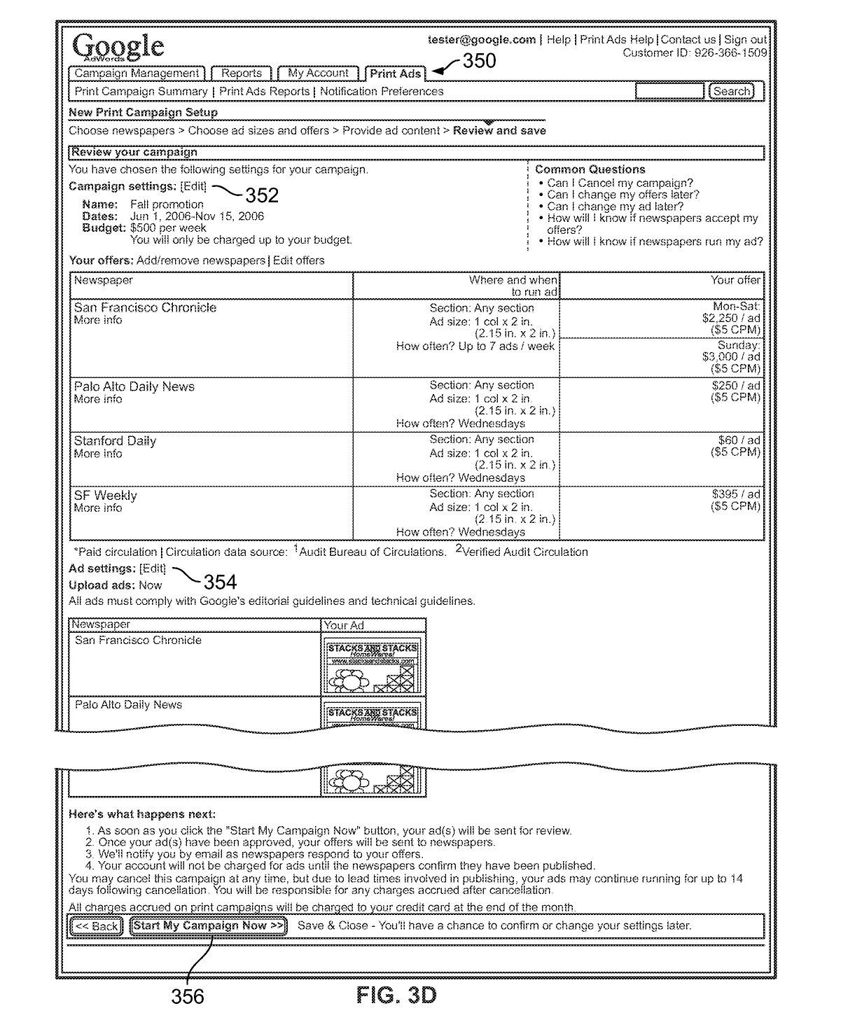

Advantageously, the advertiser 102 is provided with a central mechanism (e.g., the advertising system manager's website) to access available print ad space of, for example, multiple publishers. Correspondingly, the publishers 106 can be provided with a marketplace for their available print ad space. The payment mechanism (e.g., a bid system) can enable the advertiser 102 to only pay what the advertiser 102 decides to pay, and the publisher 106 can choose to accept only offers that are most desirous to the publisher 106. Referring now to FIGS. 3A-D, example GUIs of an example web site configured to implement the electronic advertising system provided by the advertising system manager 104 are shown. The GUIs shown in these figures are directed to the advertisers 102 and can be used to receive the advertisers' offers. These GUIs are illustrative examples, and other configurations can be used.

Referring particularly to FIG. 3A, a GUI 300 is shown for one particular example whereby an advertiser 102 is creating offers to place print ads with newspaper publishers 106. Data fields 302 and 304 are provided wherein the advertiser 102 can input a name for a print ad campaign being created (i.e., a set of offers) and the desired start and end dates for the ad campaign.

The advertiser 102 can choose to either search for names of newspapers by location using the search input field 306, or can enter a newspaper name into the data field 308. Other controls are provided for the advertiser 102 to search, for example, newspapers per the search criteria entered in the data fields, or by use of a drop down menu. A list of newspapers is provided to the advertiser 102, and in this example, the advertiser 102 has selected the first eight newspapers from the list 310. A data box 312 shown to the right of the list clearly identifies for the advertiser 102 the names of the newspapers selected and includes a “remove” control, whereby the advertiser 102 can select to remove one or more from the list. A second data box 314 provides additional information to the advertiser 102 about certain of the selected newspapers. The advertiser 102 is notified that some of the newspapers selected are a part of packages that offer discount rates if the advertiser bids on the whole package. Suggested packages to add to the list of selected newspapers are proposed to the advertiser 102. Near the bottom of the GUI 300 control buttons 316 are provided for the advertiser 102 to cancel or continue with inputting information to create offers. In this example, the advertiser 102 selects to continue.

Referring now to FIG. 3B, a next GUI 320 is shown that is presented to the advertiser 102 upon selecting to continue, as described above. Each of the newspapers selected by the advertiser 102 using the previous GUI 300 is listed beside a set of user controls. The advertiser 102 can employ the user controls to input specifics about their offer for each particular publisher 106, i.e., newspaper. In this implementation, the advertiser 102 is prompted to input the section 322 of the newspaper in which to run the print ad, the ad size 324, and the issues 326 (i.e., for a daily publication, the day(s) of the week). The advertiser 102 is also prompted to input a bid amount 328. A column to the right of the bid amount shows a calculated maximum weekly cost 330, based on the bid amount and the number of days selected.

A data box 332 can include multiple pieces of information. In this implementation, the data box 332 includes information about “overbidding”, a practice that can ensure advertisers get full use of their advertising budget. Because one or more of the advertiser's offers may not be accepted by publishers, the advertiser is recommended to create offers having a total bid amount greater than the advertiser's desired maximum weekly budget. However, only the first publishers that accept the advertiser's pending offers may secure the potential business with the advertiser. That is, a first publisher to respond to the advertiser's offers will likely be able to accept some or all of the advertiser's offers before the advertiser's maximum weekly budget is met. A last publisher to respond may not be able to accept any offers, if the advertiser's maximum weekly budget is already met by the earlier acceptance of offers by other publishers. A natural by-product of overbidding is a tacit incentive for publishers to respond quickly to advertisers offers and to minimize negotiating with advertisers, as a delay in acceptance due to negotiations can mean the offer will not longer be open for acceptance.

Control buttons 334 allow the advertiser 102 to go back to the previous GUI 300, continue or “save and close”. In this example, the advertiser 102 chooses to continue and is presented with the GUI 340 shown in FIG. 3C. The advertiser 102 can use the GUI 340 to upload files including the print ad content the advertiser 102 desires to place in one or more of the selected newspapers. In this implementation, data fields 342 are provided wherein the advertiser 102 can provide information for the publishers 106, including the advertiser's name, product/service name, product/service description, and a description of persons who may find the ad content controversial or offensive. Controls 346 are provided for the advertiser 102 to indicate whether they plan to update their ad and/or use different ad files for different issues. For example, the advertiser 102 may upload one ad file for use in issues published from Monday to Friday and a second ad file for use in issues published on the weekend. Controls 348 allow the advertiser 102 to go back to the previous GUI 320, continue or save and close.

In this example, the advertiser 102 chooses to continue and is presented with the GUI 350 shown in FIG. 3D. The advertiser 102 is presented with a summary of the ad campaign the advertiser 102 has created, including a summary of the advertiser's offers and the ad content uploaded in the ad files. The advertiser 102 can select “edit” controls 352 and 354 to edit the advertiser's offers and ad content. If the advertiser 102 is satisfied with the ad campaign as shown, the advertiser 102 can select the “start my campaign now” button 356 to initiate consideration of the offers by the corresponding publishers 106. In this implementation, the advertiser 102 is notified by email from the advertising system manager 104 as newspaper publishers 106 respond to the advertiser's offers.

In one implementation, an “in progress” campaign is saved automatically. For example, if an advertiser navigates away from the summary review page without selecting “Start My Campaign Now”, the campaign information input by the advertiser is saved. The advertising system manager 104 may be automatically alerted to have a salesperson follow-up with the advertiser to determine whether the advertiser has questions or concerns or would like to activate their ad campaign.

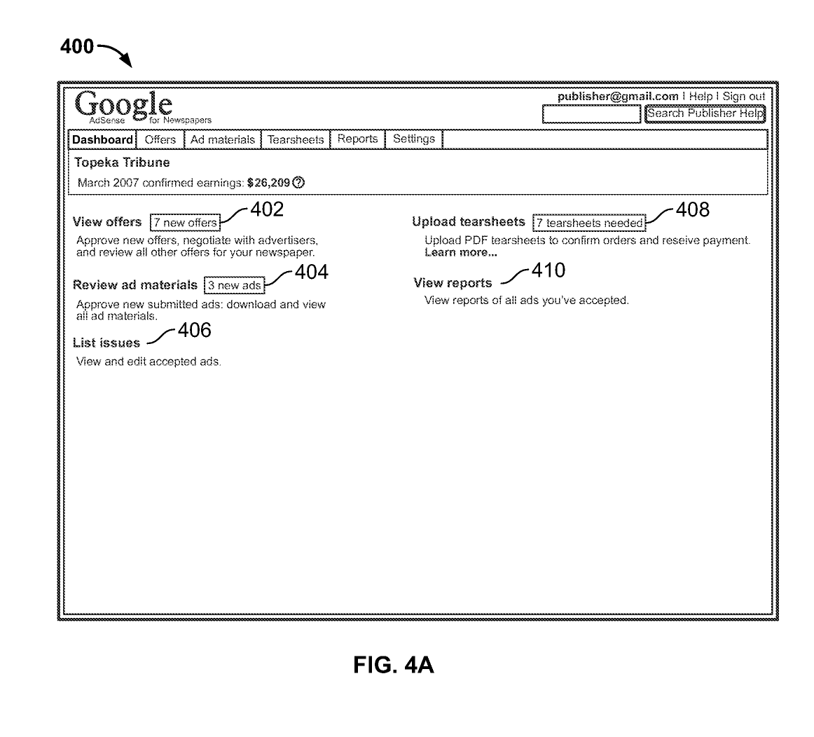

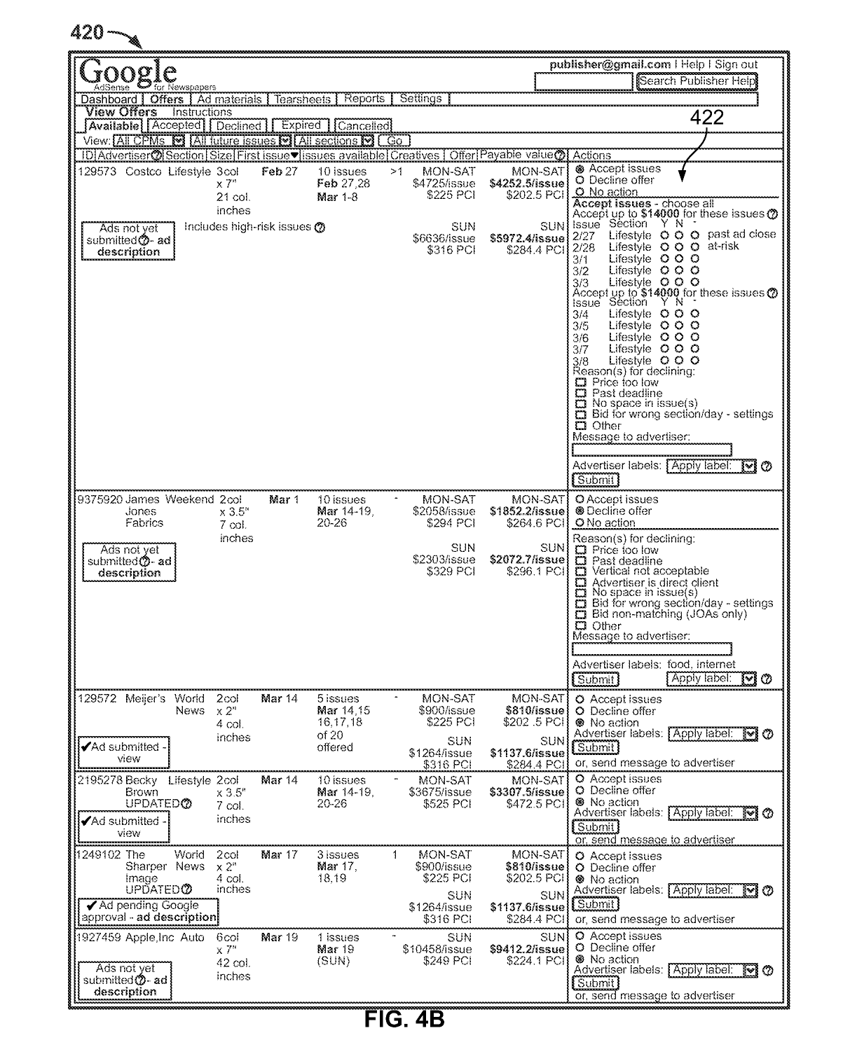

Referring now to FIGS. 4A-B, example GUIs directed to the publishers 106 are shown. These GUIs are illustrative examples, and other configurations can be used. FIG. 4A shows a GUI 400 including example content directed to a specific publisher 106, in this example, the Topeka Tribune. The publisher 106 is provided a summary of offers received 402, e.g., “7 new offers”, and provided a link to another web page to view the offers (see FIG. 4B). The publisher 106 is provided a summary of ad materials for review 404, e.g., “3 new ads” and a link to download and view the ad materials. A link to a list of issues 406 is provided to view and edit accepted ads. A summary of tearsheets needed is provided 408, e.g., “7 tearsheets needed”, and a link to upload a PDF tearsheet. A link to viewing reports 410 is provided, whereby the publisher 106 can view reports of all ads the publisher 106 has accepted. In this implementation, the publisher 106 can click on a button to view a list of offers received to place print ads in the publisher's publication.

Referring to FIG. 4B, a GUI 420 is shown that is presented upon the advertiser 102 clicking the view offers 402 link shown in FIG. 4A. Each offer received is detailed and an action column 422 is provided. The publisher 106 can input selections into controls and data fields included in the action column 422 to accept an offer, decline an offer and/or to provide reasons for declining an offer and an optional message to the advertiser 102.

As described above, once the publisher 106 proves the ad was placed as per the terms agreed to between the publisher 106 and the advertiser 102, the advertising system manager 104 automatically collects the bid amount from the advertiser 102. For example, in one implementation, the advertising system manager 104 automatically charges the bid amount to an account the advertiser 102 has with the advertising system manager 104. The advertising system manager 104 then transmits the publisher's share of the bid amount to the publisher 106 (e.g., credits the publisher's account) and retains the balance as payment to the advertising system manager 104. For example, in one implementation, the publisher's share is 85% of the bid amount. However, it should be understand a different percent or a different manner of calculating the publisher's share can be used and this is but one example.

Because payment to both the advertising system manager 104 and the publisher 106 does not occur until the publisher 106 has proved the ad has been placed, for example, by uploading an electronic tearsheet, the sooner the electronic tearsheet is uploaded, the sooner the bid amount can be collected. To encourage the publisher 106 to promptly upload the electronic tearsheet, the amount of the publisher's share is made contingent on when the electronic tearsheet is uploaded. That is, if the electronic tearsheet is uploaded within a first period of time after the ad is placed, then the publisher's share includes a base amount and a first bonus. By way of illustrative example, if the electronic tearsheet is uploaded within 24 hours of the ad being placed, then the publisher's share includes a base amount of 85% of the bid amount and a first bonus of 5% of the bid amount.

In another implementation, different bonus amounts can be provided for different upload periods. For example, if the electronic tearsheet is not uploaded within the first period of time, but is uploaded within a second period of time, then the publisher's share includes a base amount and a second bonus, where the second bonus is less than the first bonus. By way of illustration, using the example from above, if the electronic tearsheet is uploaded after 24 hours but before 48 hours of the ad being placed, then the publisher's share increases from 85% to 88% of the bid amount, i.e., a 3% second bonus.

In another implementation, if the electronic tearsheet is not uploaded within a final period of time, then no payment is collected from the advertiser 102 and neither the advertising system manager 104 nor the publisher 106 get paid for the ad, even if the ad was placed according to the terms agreed to by the publisher 106 and the advertiser 102.

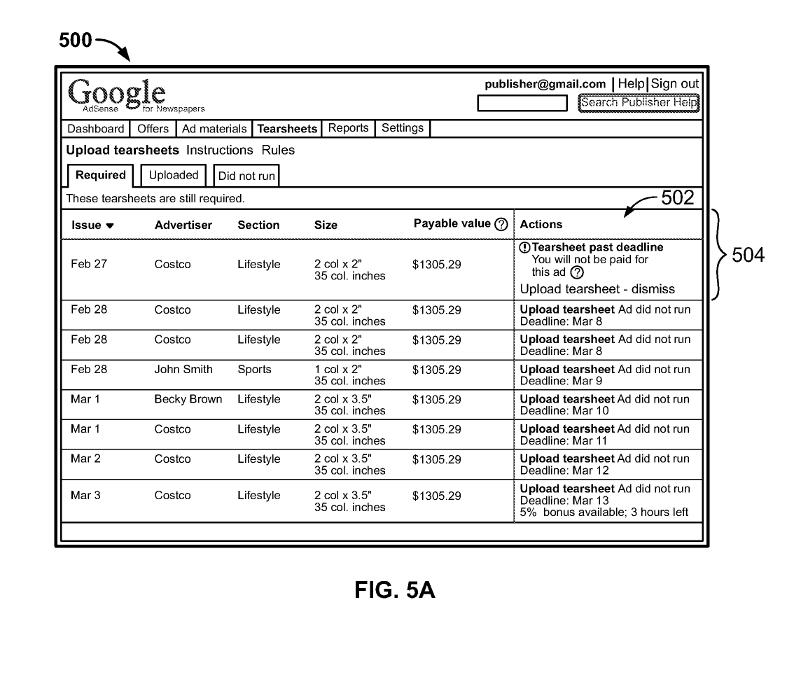

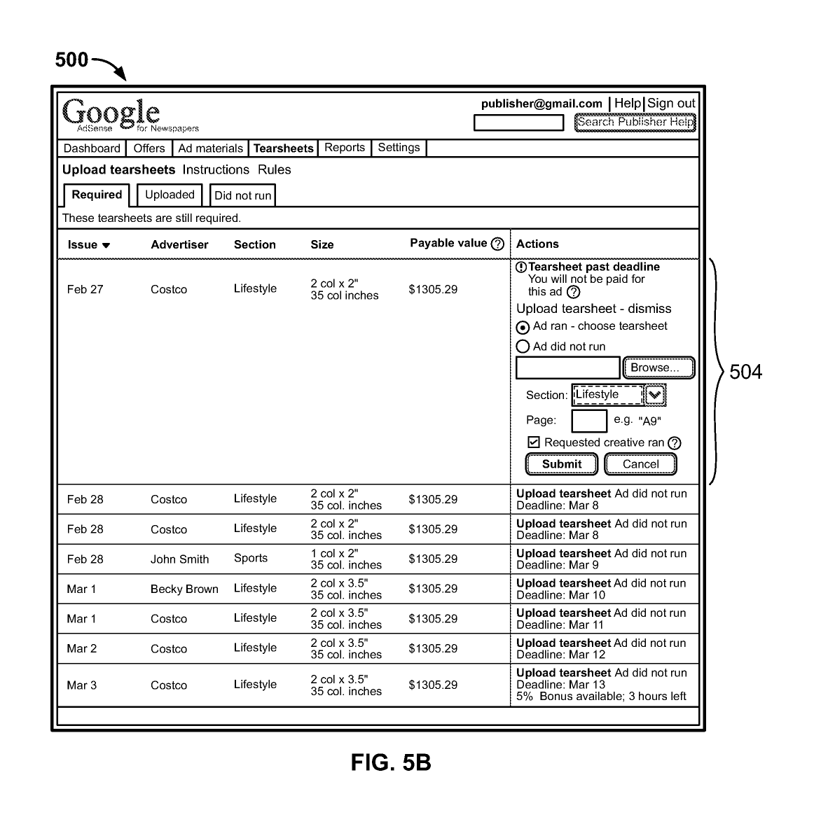

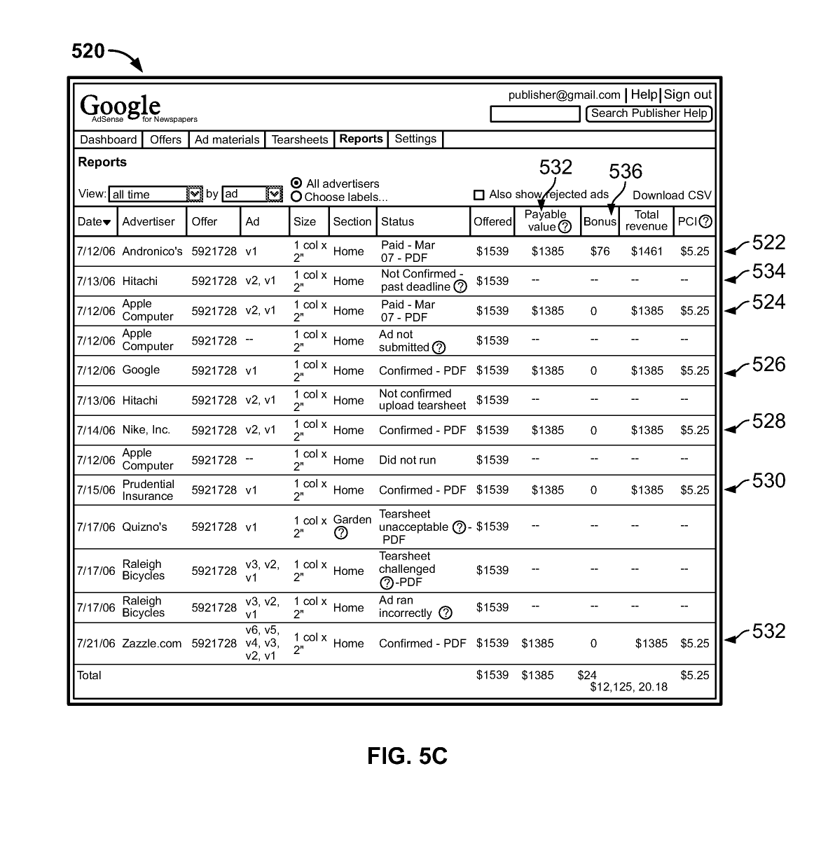

Referring to FIGS. 5A-C, example GUIs directed toward the publisher 106 are shown. These GUIs are illustrative examples, and other configurations can be used. Referring again to FIG. 4A, if a publisher selects the “upload tearsheets” item 408, the GUI 500 shown in FIG. 5A is presented to the publisher 106 in the illustrative implementation shown. The GUI 500 shows a list of seven ads that the publisher 106 agreed to place and includes an action column 502. The action column 502 provides the status of electronic tearsheet uploading. That is, a deadline is given by which the electronic tearsheet must be uploaded in order to collect payment or other compensation for placing the ad. In the example shown, the final deadline to upload an electronic tearsheet to collect payment is 10 days from date the ad was placed. The first item 504 in the action column 502 indicates that an electronic tearsheet is past the deadline and the publisher 106 is notified that they will not be paid for the ad.

Referring to FIG. 5B, if the publisher 106 chooses to take action with respect to the first item 504 in the action column 502, for example, by clicking on the item 504, the item 504 expands and presents a number of user controls to the publisher 106. The publisher 106 can employ the user controls to upload an electronic tearsheet, indicate whether or not the ad ran and if so, specify the section and page number, and confirm that the requested creative (i.e., ad content) ran. In this example, for this particular item 504, even if the publisher 106 uploads the electronic tearsheet and proves that the ad ran, because the publisher 106 exceeded the maximum allowable period to upload the tearsheet, the publisher 106 will not be paid. Similarly, if the publisher self-reports that the ad was placed in a section of the newspaper different than that agreed to, such an execution error may result in non-payment for the ad.

Referring to FIG. 5C, shows an example user interface associated with a report of ads the publisher agreed to run. For example, referring to FIG. 4A, by selecting the “view reports” item 410, the report shown in the GUI 520 in FIG. 5C is generated and displayed. The report includes a “payable value” column 522 that includes the bid amount payable to the publisher 106 for placing the ad and uploading the electronic tearsheet within the maximum allowable time period. The ads identified in rows 522, 524, 526, 528 and 530 ran and the electronic tearsheets were timely uploaded; accordingly a payable amount of the publisher's share of the bid amount is shown in column 532. The ad identified by row 534 has a status of “not confirmed—past deadline” and no payable amount is indicated in column 532. The publisher 106 did not upload the electronic tearsheet confirming the ad was placed as agreed, and accordingly the publisher 106 will not be paid for the ad. In other cases, the ad either was not submitted, ran incorrectly, has not yet been confirmed or an advertiser has challenged the tearsheet. In these instances, no amount is indicated as payable to the publisher 106.

The report further includes a “bonus” column 536. The bonus column indicates if the publisher 106 is entitled to a bonus share of the bid amount due to prompt uploading of the electronic tearsheet within a certain specified bonus period, and the amount thereof. For example, the ad identified by the first row in column 536 earned the publisher 106 a bonus of $76 due to the publisher 106 having uploaded the electronic tearsheet confirming the ad was placed within a specified bonus period, for example, 24 hours after the ad ran. None of the other ads that ran and have payable amounts indicated in column 532 have corresponding bonus amounts, indicating that although the electronic tearsheets were uploaded by the publisher 106 within the maximum period of time allowable to receive payment, they were uploaded later than the bonus period of time.

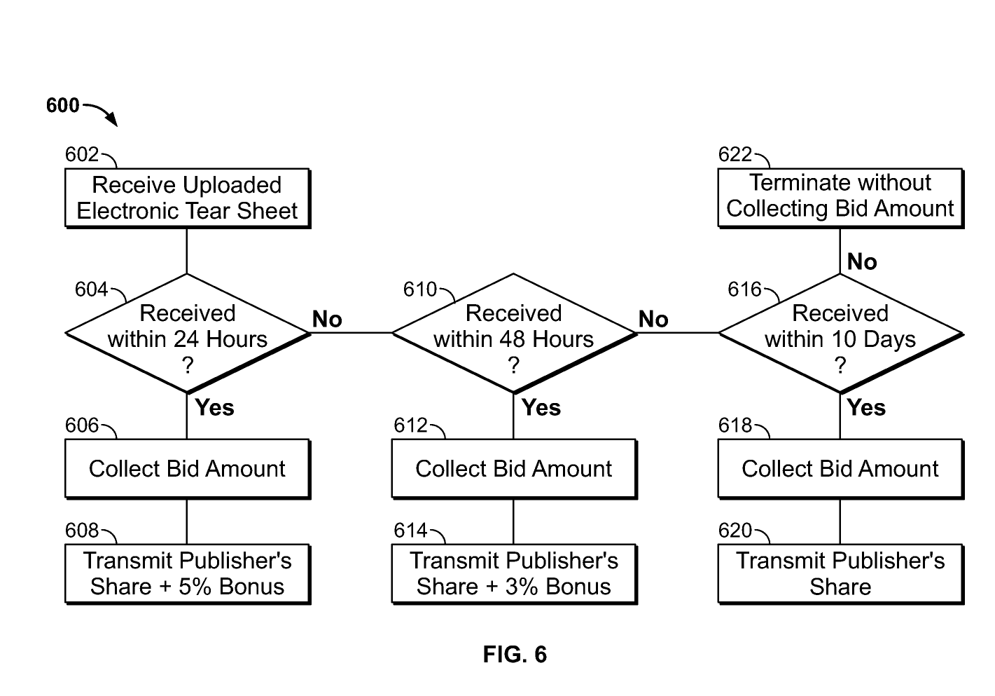

Referring to FIG. 6, a flowchart showing an example process 600 for determining a publisher's payable value for an ad based on when the electronic tearsheet was uploaded to the advertising system manager 104 is shown. The process 600 described is one implementation for illustrative purposes, and can be carried out in a different order or with more or fewer steps, and including different time periods and bonus amounts. The process 600 initiates once an advertiser's offer has been accepted by a publisher 106, the date to run the ad has passed and an electronic tearsheet has been uploaded by the publisher 106 and received by the advertising system manager 104 (Step 602). If the electronic tearsheet is determined to have been uploaded within a first time period, e.g., 24 hours, of running the print ad (“Yes” branch of decision step 604), then the bid amount is collected from the advertiser 102 (Step 606). The publisher 106 is provided a predetermined share (e.g., 85%) of the bid amount plus an additional bonus (e.g., 5%) for uploading the electronic tearsheet within the first predetermined time period (Step 608).

If the electronic tearsheet was not uploaded within the first predetermined time period (“No” branch of decision step 604), but was uploaded within a second longer predetermined time period (e.g., 48 hours) of running the ad (“Yes” branch of decision step 610), then the bid amount is collected from the advertiser 102 (Step 612). The publisher 106 is provided a share being (e.g., 85%) of the bid amount plus an additional lesser bonus (e.g., 3%) for uploading the electronic spreadsheet within the second predetermined time period of running the ad (Step 614).

If the electronic tearsheet was not uploaded within the second predetermined time period (e.g., 48 hours) (“No” branch of decision step 610), but was uploaded within the maximum allowable time period (e.g., 10 days) (“Yes” branch of decision step 616), then the bid amount is collected from the advertiser 102 (Step 618). The publisher 106 is provided a share (e.g., 85%) of the bid amount; no bonus is payable (Step 620).

If the electronic tearsheet is uploaded outside of the maximum allowable time period (“No” branch of decision step 616), then the process terminates and the bid amount is not collected from the advertiser 102 (Step 622).

In the above example, the publisher's incentive for good performance is a monetary bonus. However, in other implementations, different techniques can be used to provide an incentive to publishers. For example, a publisher can be provided a future discount with a same advertiser. In another example, a rating system can be employed, for example, where advertisers provide feedback to the advertising system manager 104 about a publisher's performance. Based on feedback accumulated from various advertisers, the advertising system manager 104 can provide a star rating or similar type of rating to indicate the historical overall satisfaction and/or dissatisfaction of advertisers with the publisher.

In the example above, the publisher's performance is monitored and rewarded on a per-ad-insertion basis. In other implementations, the publisher's performance can be rewarded on a different basis, for example, on a per-campaign basis relating to a particular advertiser campaign, or on the basis of the last predetermined number of ads, e.g., performance for the last 10 ads placed. By way of illustrative example, an advertiser campaign may include placing the ad in a newspaper for an entire week. In order for the publisher to earn their bonus, the publisher may be required to upload the electronic tearsheets for each day the ad is placed within 24 hours of placement before being eligible for a bonus or other publisher incentive.

In the above example, the publishers performance is monitored based on the time it takes a publisher to upload an electronic tearsheet. However, in other implementations, different factors can be monitored as indications of good performance. For example, other performance factors can include: time to respond to new offers; placement quality of print ads; percentage of print ad placements that are correctly executed; an advertiser satisfaction rating of interaction with the publisher and/or publisher ad performance. Rating the publishers performance based on one or more of the above factors, or other factors, can be systematic and automated, can be advertiser-specified or can be qualitatively judged by the advertising system manager 104.

The invention and all of the functional operations described in this specification can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

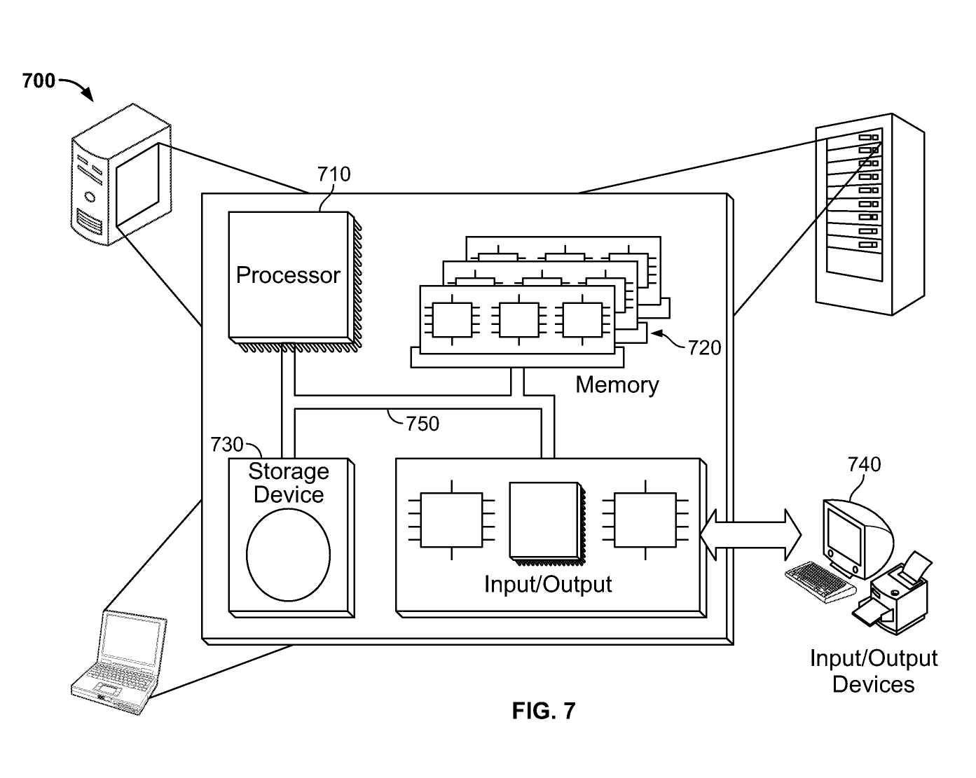

Referring now to FIG. 7, a schematic diagram of an example computer system 700 is shown. The system 700 can be used for the operations described in association with the process 700 shown in FIG. 7, according to one implementation. For example, one or more of the systems 700 can be used to implement a server hosting the advertising system manager 104, the advertisers 102 and/or the publishers 106 (see FIG. 1).

The system 700 includes a processor 710, a memory 720, a storage device 730, and an input/output device 740. Each of the components 710, 720, 730, and 740 can, for example, be interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740. In some embodiments, a parallel processing set of systems 700 connected over a network may be employed, clustered into one or more server centers.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can, for example, include a hard disk device, an optical disk device, or some other large capacity storage device.

The input/output device 740 provides input/output operations for the system 700. In one implementation, the input/output device 740 includes a keyboard and/or pointing device. In another implementation, the input/output device 740 includes a display unit for displaying graphical user interfaces.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method comprising:
receiving publisher information from a plurality of publishers including information about available print ad space;
receiving an offer from an advertiser specifying terms for placing a print ad in a publication of a publisher, the terms including a bid amount being an amount the advertiser is willing to pay for placing the print ad;
receiving an acceptance from the publisher of the offer;
receiving print ad content from the advertiser and providing the print ad content to the publisher;
receiving at a receipt time an electronic tearsheet from the publisher confirming placement at a placement time of the print ad in the publication according to the terms;
collecting the bid amount from the advertiser; and
providing a publisher's share of the bid amount to the publisher, where the publisher's share comprises a base amount and a bonus, and the bonus is based on a period of time between the receipt time and the placement time.

2. The method of claim 1, wherein if the period of time between the receipt time and the placement time is 24 hours or less, then the bonus comprises a first amount.

3. The method of claim 2, wherein the base amount comprises 85% of the bid amount and the first amount comprises 5% of the bid amount.

4. The method of claim 2, wherein if the period of time between the receipt time and the placement time is greater than 24 hours but less than 48 hours, then the bonus comprises a second amount.

5. The method of claim 4, wherein the base amount comprises 85% of the bid amount, the first amount comprises 5% of the bid amount and the second amount comprises 3% of the bid amount.

6. The method of claim 1, wherein if the period of time between the receipt time and the placement time is greater than 48 hours, then the bonus is zero.

7. The method of claim 1, wherein the base amount depends on the period of time between the receipt time and the placement time and if the period of time exceeds a maximum allowable time then the base amount is zero.

8. The method of claim 1, wherein the bonus comprises a performance rating on a performance scale, where a value of the performance rating is based on the period of time between the placement time and the receipt time.

9. A computer-implemented method comprising:
receiving at a receipt time an electronic tearsheet from a publisher confirming placement at a placement time of a print ad in a publication according to specified terms between the publisher and an advertiser, the specified terms including a bid amount;
collecting the bid amount from the advertiser; and
providing a publisher's share of the bid amount to the publisher, where the publisher's share comprises a base amount and a bonus, and the bonus is based on a period of time between the receipt time and the placement time.

10. The method of claim 9, wherein if the period of time between the receipt time and the placement time is 24 hours or less, then the bonus comprises a first amount.

11. The method of claim 10, wherein the base amount comprises 85% of the bid amount and the first amount comprises 5% of the bid amount.

12. The method of claim 10, wherein if the period of time between the receipt time and the placement time is greater than 24 hours but less than 48 hours, then the bonus comprises a second amount.

13. The method of claim 12, wherein the base amount comprises 85% of the bid amount, the first amount comprises 5% of the bid amount and the second amount comprises 3% of the bid amount.

14. The method of claim 9, wherein if the period of time between the receipt time and the placement time is greater than 48 hours, then the bonus is zero.

15. The method of claim 9, wherein the base amount depends on the period of time between the receipt time and the placement time and if the period of time exceeds a maximum allowable time then the base amount is zero.

16. The method of claim 9, wherein the bonus comprises a performance rating on a performance scale, where a value of the performance rating is based on the period of time between the placement time and the receipt time.

17. An electronic advertising system, comprising:
a user interface configured to receive:
publisher information from a plurality of publishers, where publisher information includes information about a publication and available print ad space in the publication; and
offers from a plurality of advertisers, where an offer specifies terms for placing a print ad in a publication of a publisher, the terms including a bid amount being an amount the advertiser is willing to pay for placing the print ad;
means for electronically receiving print ad content from an advertiser and electronically providing the print ad content to a publisher, where the publisher has accepted an offer to place the print ad in a publication;
means for receiving at a receipt time an electronic tearsheet from a publisher confirming placement at a placement time of the print ad in the publication according to the terms;
means for calculating an amount payable to the publisher for placement of the print ad in the publication, the amount payable comprising a base amount and a bonus where the bonus is based on a period of time between the placement time and the receipt time and can be zero; and
means for collecting the bid amount from the advertiser and providing to the publisher the calculated amount payable to the publisher.

18. The system of claim 17, wherein if the period of time between the receipt time and the placement time is 24 hours or less, then the bonus comprises a first amount.

19. The system of claim 18, wherein the base amount comprises 85% of the bid amount and the first amount comprises 5% of the bid amount.

20. The system of claim 18, wherein if the period of time between the receipt time and the placement time is greater than 24 hours but less than 48 hours, then the bonus comprises a second amount.

21. The system of claim 20, wherein the base amount comprises 85% of the bid amount, the first amount comprises 5% of the bid amount and the second amount comprises 3% of the bid amount.

22. The system of claim 17, wherein if the period of time between the receipt time and the placement time is greater than 48 hours, then the bonus is zero.

23. The system of claim 17, wherein the base amount depends on the period of time between the receipt time and the placement time and if the period of time exceeds a maximum allowable time then the base amount is zero.
